(19) United States
(12) Patent Application Publication
(10) Pub. No.: US 2012/0330677 A1
(43) Pub. Date: Dec. 27, 2012

(54) Healthcare Optimization Systems and Methods

(76) Inventor: James G. Velimesis, Alpharetta, GA (US)

(21) Appl. No.: 13/533,545

(22) Filed: Jun. 26, 2012

Related U.S. Application Data
(60) Provisional application No. 61/501,751, filed on Jun. 27, 2011.

(51) Int. Cl. G06Q 50/22

(52) U.S. Cl. 705/2

(57) ABSTRACT

A computer system for determining an optimized patient treatment protocol is adapted to perform the steps of: (1) obtaining a first cost of labor and materials, patient satisfaction level, and protocol quality indicator associated with a first proposed treatment protocol (PTP); (2) obtaining a second cost of labor and materials, patient satisfaction level, and protocol quality indicator associated with a second proposed treatment protocol (PTP); (3) assigning a first rating to PTP based on the first cost of labor and material, first patient satisfaction level and first protocol quality indicator; (4) assigning a second rating to the second PTP based on the second cost of labor and material, second patient satisfaction level and second protocol quality indicator; (5) performing a comparison of the first and second ratings; and (6) determining which of the first and second proposed treatment protocols to implement as the optimized patient treatment protocol.

### CROSS REFERENCE TO RELATED APPLICATIONS

This application claims priority from U.S. Provisional Application 61/501,751 filed on Jun. 27, 2011 entitled Healthcare Optimization Systems and Methods, which is hereby incorporated herein by reference in its entirety.

### BACKGROUND

Hospitals are faced with the challenge of improving the quality of the health care they provide, improving the experience of patients to whom they provide health care, and reducing the cost of providing health care to their patients. Altering any one of these factors of quality of health care, patient satisfaction, and cost can have an impact on the other factors. Often, for example, patient satisfaction or quality of healthcare will suffer as a result of reducing the cost of health care to the patient. Accordingly, there is a need for improved systems and methods for optimizing the balance between quality of health care, patient satisfaction, and health care costs.

### SUMMARY

A computer system, according to various embodiments, for determining an optimized patient treatment protocol, comprises at least one processor and memory. In certain embodiments, the system is adapted to perform the steps of: (1) obtaining a first cost of labor and materials associated with a first proposed treatment protocol; (2) obtaining a first patient satisfaction level associated with the first proposed treatment protocol; (3) obtaining a first protocol quality indicator that indicates a quality of results of the first proposed treatment protocol; (4) obtaining a second cost of labor and materials associated with a second proposed treatment protocol; (5) obtaining a second patient satisfaction level associated with the second proposed treatment protocol; (6) obtaining a second protocol quality indicator that indicates a quality of results of the second proposed treatment protocol; (7) assigning a first rating to the first proposed treatment protocol based, at least in part, on the first cost of labor and materials, the first patient satisfaction level, and the first protocol quality indicator; (8) assigning a second rating to the second proposed treatment protocol based, at least in part, on the second cost of labor and materials, the second patient satisfaction level, and the second protocol quality indicator; (9) performing a comparison of the first and second ratings; and (10) based, at least in part, on the comparison, determining which of the first and second proposed treatment protocols to implement as the optimized treatment protocol.

A method, according to particular embodiments, of determining an optimized treatment protocol, comprises the following steps: (1) obtaining a first cost of labor and materials associated with a first proposed treatment protocol; (2) obtaining a first patient satisfaction level associated with the first proposed treatment protocol; (3) obtaining a first protocol quality indicator that indicates a quality of results of the first proposed treatment protocol; (4) obtaining a second cost of labor and materials associated with a second proposed treatment protocol; (5) obtaining a second patient satisfaction level associated with the second proposed treatment protocol; (6) obtaining a second protocol quality indicator that indicates a quality of results of the second proposed treatment protocol; (7) determining a cost difference between implementing the first and second proposed treatment protocols; (8) determining a quality of difference between implementing the first and second proposed treatment protocols; (9) determining, based at least on the cost difference and quality difference, which of the first and second proposed treatment protocols to implement as the optimized treatment protocol. In particular embodiments: (1) the step of determining the cost difference is based, at least in part, on the first cost of labor and materials, the first patient satisfaction level, the second cost of labor and materials, and the second patient satisfaction level; and (2) the step of determining the quality difference is based, at least in part, on the first and second protocol quality indicator.

A computer system, according to various embodiments, for determining which drug to use in the context of a particular medical procedure, comprises at least one processor and memory. In certain embodiments, the system is adapted for: (1) obtaining first cost information indicating a cost of labor and materials associated with using a first drug in the particular medical procedure; (2) obtaining first patient satisfaction information indicating a level of patient satisfaction associated with the particular medical procedure when the first drug is used in the particular medical procedure; (3) obtaining second cost information indicating a cost of labor and materials associated with using a second drug in the particular medical procedure; (4) obtaining second patient satisfaction information indicating a level of patient satisfaction associated with the particular medical procedure when the second drug is used in the particular medical procedure; (5) determining a cost difference between: (A) using the first drug in the particular medical procedure; and (B) using the second drug in the particular medical procedure; and (6) communicating the cost difference to a user. In particular embodiments, the computer system is adapted for, at Step (5), determining the cost difference based, at least in part, on the first cost information, first patient satisfaction information, second cost information, and/or second patient satisfaction information.

A computer system, according to various embodiments, for determining which treatment technique to use in the context of a particular medical procedure, comprises at least one processor and memory. In certain embodiments, the system is adapted for: (1) obtaining first cost information indicating a cost of labor and materials associated with using a first treatment technique in the context of the particular medical procedure; (2) obtaining first patient satisfaction information indicating a level of patient satisfaction associated with the particular medical procedure when the first treatment technique is used in the context of the particular medical procedure; (3) obtaining second cost information indicating a cost of labor and materials associated with using a second treatment technique in the context of the particular medical procedure; (4) obtaining second patient satisfaction information indicating a level of patient satisfaction associated with the particular medical procedure when the second treatment technique is used in the context of the particular medical procedure; (5) determining a cost difference between: (A) using the first treatment technique in the context of the particular medical procedure; and (B) using the second treatment technique in the context of the particular medical procedure; and (6) communicating the cost difference to a user. In particular embodiments, the computer system is adapted for, at Step (5), determining the cost difference based, at least in part, on first cost information, first patient satisfaction information, second cost information, and/or second patient satisfaction information.

### BRIEF DESCRIPTION OF THE DRAWINGS

Having thus described various embodiments in general terms, reference will now be made to the accompanying drawings, which are not necessarily drawn to scale, and wherein:

FIG. 1 is a block diagram of a system according to one embodiment.

FIG. 2 is a block diagram of an Optimization Server of FIG. 1.

FIGS. 3A and 3B depict a flowchart that generally illustrates a Patient Treatment Optimization Module according to a particular embodiment.

FIGS. 4A and 4B depict a flowchart that generally illustrates a Cost-Based Treatment Optimization Module according to a particular embodiment.

FIG. 5 depicts a flowchart that generally illustrates a Drug Selection Module according to a particular embodiment.

FIG. 6 depicts a flowchart that generally illustrates a Treatment Technique Determination Module according to a particular embodiment.

FIG. 7 is a screen display that shows a case information screen according to a particular embodiment.

FIG. 8 is a screen display that shows a codes screen according to a particular embodiment.

### DETAILED DESCRIPTION OF VARIOUS EMBODIMENTS

Various embodiments will now be described more fully hereinafter with reference to the accompanying drawings, in which various relevant embodiments are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable non-transitory computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Overview

A healthcare optimization system according to various embodiments comprises one or more central servers and one or more data collection computer devices that are connected to communicate with the central servers via any suitable network (e.g., the Internet or a LAN). In particular embodiments, the data collection computer devices may be handheld tablet computers or smartphones that are adapted to communicate with the system's central servers via a wireless network. It should be understood, however, that any other suitable hardware arrangement may be used to implement various embodiments of the systems described below.

In particular embodiments, the system is adapted to obtain, save to memory, and process data related to various medical procedures, and to use the information to optimize one or more particular aspects of a set of standard patient treatment procedures and/or treatment plans for a particular patient. For example, the system may be used to: (1) obtain and process data regarding the cost, quality of results, and patient satisfaction associated with a plurality of different patient treatment protocols; (2) for each respective treatment protocol, generate a treatment protocol rating based, at least in part, on this information; and (3) provide a recommendation as to which treatment protocol provides the best results based on the generated treatment protocol ratings. The system may provide this recommendation by, for example, displaying the recommendation on a computer display screen, printing the recommendation, transmitting the recommendation to a remote computing device, or through any other suitable method. The same or similar techniques may be used to evaluate and choose between drugs, anesthetics, medical professionals (e.g., surgeons, anesthesiologists, and other medical professionals who are involved in a particular medical procedure) or any other aspect of a healthcare-related procedure, or other procedure.

In various embodiments, the system may be adapted to convert data regarding the quality of results (e.g., the quality of results associated with a certain treatment protocol) into a quantified cost or cost savings. For example, the system may be adapted to calculate the cost savings or additional cost associated with a particular quality of outcome for a particular procedure. For example, a certain high-quality procedure that results in very low incidences of patient nausea and vomiting may be assigned a net cost value of negative $250 (to reflect an average cost savings of $250), which would reflect cost savings associated with not having to treat patients for nausea.

Similarly, the system may be adapted to convert data regarding patient satisfaction into a quantified amount. For example, the system may be adapted to calculate the additional cost or cost savings associated with receiving certain customer satisfaction ratings for a particular procedure. Such additional costs may come, for example, in the form of reduced government payments (e.g., penalties for low customer satisfaction), or projected increases in revenue due to payment bonuses associated with high levels of customer satisfaction.

Once quality and customer satisfaction data is converted into quantified cost savings/additional cost information, the data may be used, as discussed above, to evaluate and choose between drugs, anesthetics, medical professionals (e.g., surgeons, anesthesiologists, and other medical professionals who are involved in a particular medical procedure) or any other aspect of a healthcare-related procedure, or other procedure.

As a particular example, the system may, in certain embodiments, be adapted to assign an overall numerical rating (or other rating) to a first treatment pathway based, at least in part, on: (1) the cost of labor and materials associated with the treatment pathway; (2) the projected average cost savings or additional cost associated with the average quality of results obtained by using the treatment pathway; and (3) the projected average cost savings or additional cost associated with the average patient satisfaction data obtained by using the treatment pathway. This same technique may then be used to assign a similar rating to a second treatment pathway. The system may then compare the two treatment pathways by comparing the pathways' respective ratings. The system (or a human user of the system) may then use this comparison to prepare an optimized treatment plan (e.g., for generalized use in a particular hospital, or for use in treating a particular patient).

In particular embodiments, any suitable combination of factors may be used in assigning a rating to a particular treatment pathway, and the combination of factors may be customized by a particular user. For example, the Chief of Anesthesiology at a first particular hospital may configure the system so that it uses only cost data to rate particular treatment pathways. However, the Chief of Anesthesiology at a second particular hospital may configure the system so that it uses both cost and quality data to rate the same treatment pathways. In particular embodiments, the system is adapted to allow a user to assign particular weighting factors to cost, quality, and patient satisfaction (or other factors) to customize the way that the system derives the ratings of various treatment pathways.

While the system is especially useful in evaluating and comparing different treatment pathways, the same techniques may be used to evaluate and compare other aspects of a particular patient treatment process. Such factors include: (1) the type of anesthetic to be used on a patient (e.g., during a particular procedure); (2) which drugs to prescribe to a patient under a particular set of circumstances; and/or (3) the performance of particular physicians in various aspects of their practice.

The system may also be used to help optimize various combinations of patient treatment factors. For example, the system may be used to determine which particular drugs have proven to deliver the best combination of cost effectiveness, quality of results, and patient satisfaction when a particular surgeon performs a particular surgical procedure.

As another example, the system may be used to help maximize CMS (government) reimbursement for various medical procedures, especially in situations in which cost, quality, and/or patient satisfaction are used by the government as factors in determining reimbursement for such procedures.

As a further example, the system may be used by a particular hospital department (e.g., an anesthesia department) to help quantify the department's contributions to cost reductions involving multiple hospital departments. The system may do this, for example, by monetizing such factors as quality and patient satisfaction data. The system may also monetize currently non-reimbursable department contributions like preoperative evaluations and peripheral nerve bocks (both of which may decrease a patient's length of stay in a hospital in a quantifiable way).

### Exemplary System Architecture

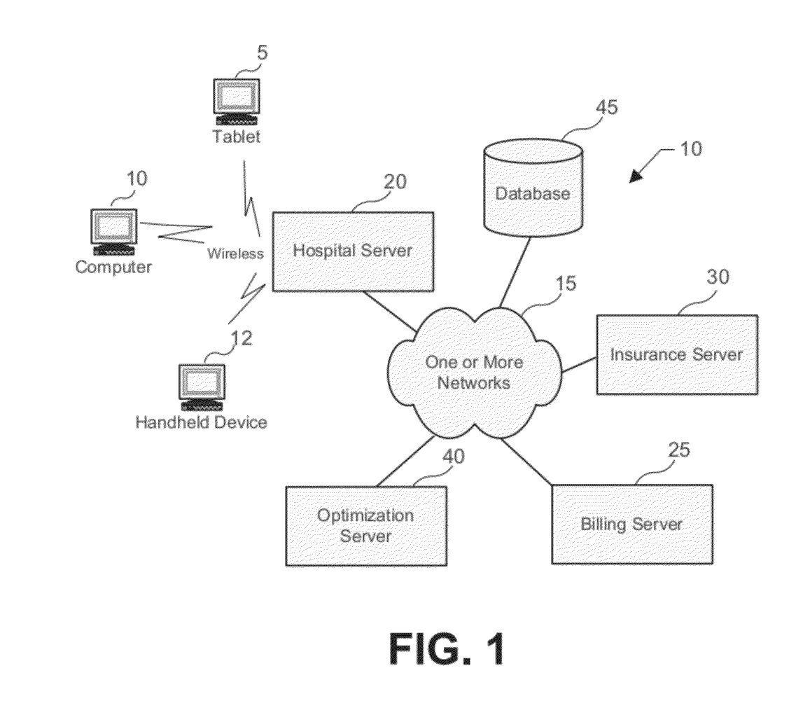

FIG. 1 shows a block diagram of a Healthcare Optimization System 10 according to a particular embodiment. As may be understood from this figure, the Healthcare Optimization System 10 includes a Hospital Server 20, an Optimization Server 40, a Billing Server 25, an Insurance Server 30, one or more computer networks 15, a Database 45, at least one Tablet 5, at least one Desktop Computer 10, and at least one Handheld Device 12. The one or more computer networks 15 facilitate communication between the Hospital Server 20, Optimization Server 40, Billing Server 25, Insurance Server 30, and Database 45. In various embodiments, the Tablet 5, Desktop Computer 10, and Handheld Device 12 communicate with a hospital server via a suitable wireless network (e.g., a wireless LAN), and may also be able to communicate with the system's other various components via the one or more networks 15. The one or more computer networks 15 may include, for example, any of a variety of types of computer networks such as the Internet, a private intranet, a public switch telephone network (PSTN), or any other type of network known in the art. In certain variations of the embodiment shown in FIG. 1, the communication link between the Hospital Server 20, Optimization Server 40, Billing Server 25, Insurance Server 30, Database 45, Tablet 5, Computer 10, and Handheld Device 12 are implemented via the Internet using Internet protocol (IP). The communication link between the Optimization Server 40 and the Database 45 may be, for example, implemented via a Local Area Network (LAN).

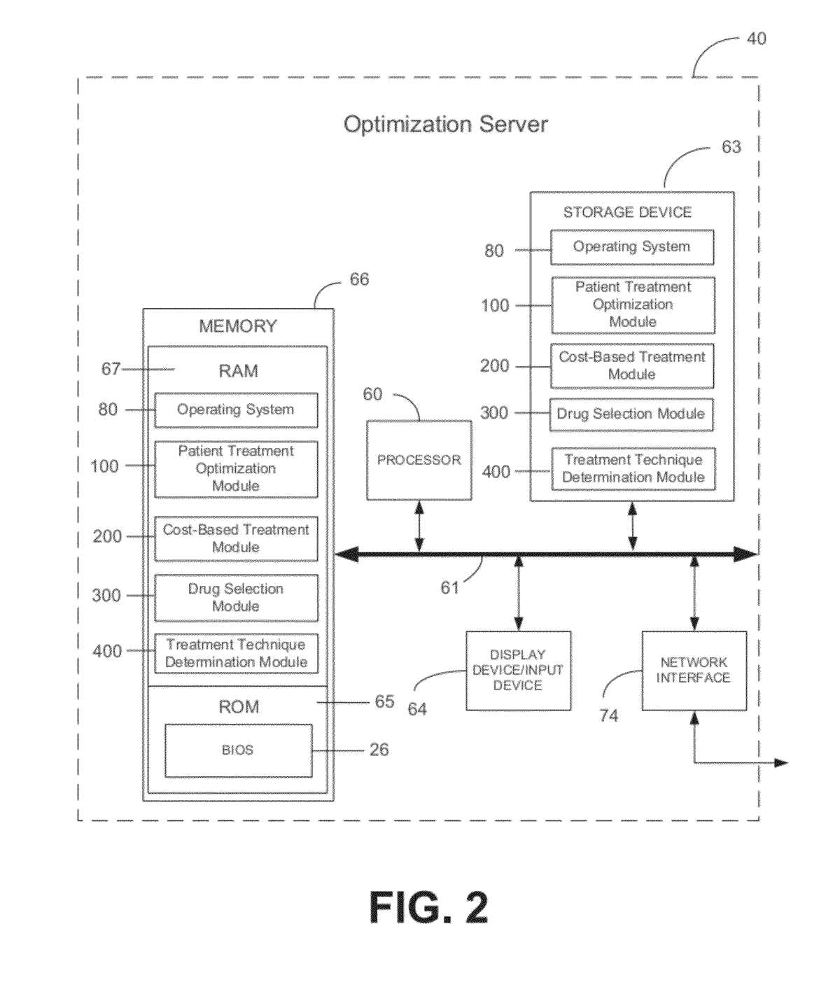

FIG. 2 shows a block diagram of an exemplary embodiment of the Optimization Server 40 of FIG. 1. The Optimization Server 40 includes a processor 60 that communicates with other elements within the Optimization Server 40 via a system interface or bus 61. Also included in the Optimization Server 40 is a display device/input device 64 for receiving and displaying data. This display device/input device 64 may be, for example, a keyboard, voice recognition, or pointing device that is used in combination with a monitor. The Optimization Server 40 further includes memory 66, which preferably includes both read only memory (ROM) 65 and random access memory (RAM) 67. The server's ROM 65 is used to store a basic input/output system 26 (BIOS) that contains the basic routines that help to transfer information between elements within the Optimization Server 40.

In addition, the Optimization Server 40 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for the Optimization Server 40. It is important to note that the computer-readable media described above could be replaced by any other type of computer-readable media known in the art. Such media include, for example, external hard drives, compact disks, flash memory cards, or digital video disks.

A number of program modules may be stored by the various storage devices and within RAM 67. Such program modules include an operating system 80, a Patient Treatment Optimization Module 100, a Cost-Based Treatment Module 200, a Drug Selection Module 300, and a Treatment Technique Determination Module 400. The Patient Treatment Optimization Module 100, Cost-Based Treatment Module 200, Drug Selection Module 300, and Treatment Technique Determination Module 400 control certain aspects of the operation of the Optimization Server 40, as is described in more detail below, with the assistance of the processor 60 and an operating system 80.

Also located within the Optimization Server 40 is a network interface 74 for interfacing and communicating with other elements of a computer network. It will be appreciated by one of ordinary skill in the art that one or more of the Optimization Server 40 components may be located geographically remotely from other Optimization Server 40 components. Furthermore, one or more of the components may be combined, and additional components performing functions described herein may be included in the Optimization Server 40.

### Exemplary System Modules

As noted above, various aspects of the system's functionality may be executed by certain system modules, including the system's Patient Treatment Optimization Module 100, Cost-Based Treatment Module 200, Drug Selection Module 300, and Treatment Technique Determination Module 400. These modules are discussed in greater detail below.

Patient Treatment Optimization Module

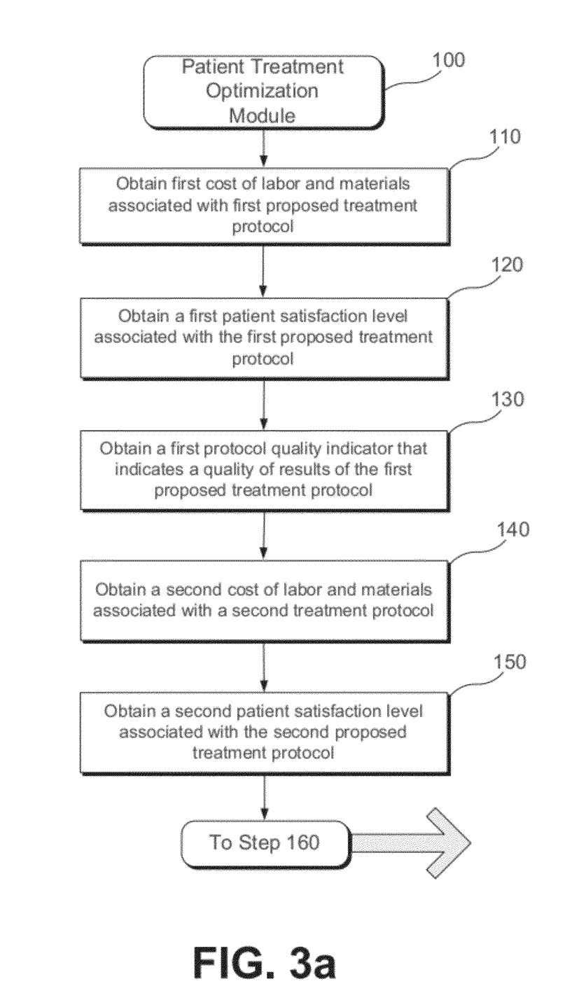

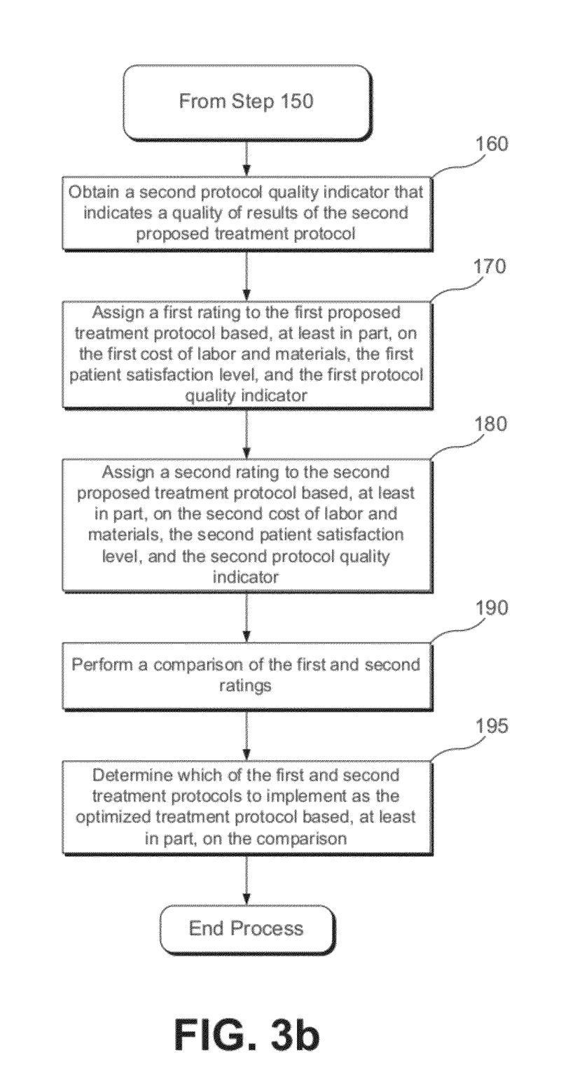

FIGS. 3A and 3B depict a flow chart of an exemplary Patient Treatment Optimization Module 100. As may be understood from these figures, certain embodiments of the Patient Treatment Optimization Module 100 are configured to allow a system user to determine an optimized patient treatment protocol based on data gathered for two treatment protocols. For example, the system may be used to determine which of two post-op treatments are most effective based on such factors as quality of results, patient satisfaction, and/or cost savings. Beginning at Step 110, the system obtains a first cost of labor and materials associated with a first proposed treatment protocol. In particular embodiments, point of service billing data, employee productivity statistics, and/or data entered by one or more medical professionals through wireless devices are used to obtain the cost of labor and materials associated with the first proposed treatment protocol. The system then obtains, at Step 120, a patient satisfaction level associated with this proposed protocol. This satisfaction level may, for example, be derived from a satisfaction survey of one or more patients who have received the first treatment protocol. Next, at Step 130, the system continues by obtaining a protocol quality indicator obtained, for example, from a surveyed group of patients using this treatment protocol or from other suitable data sources. Variables that may be considered include, for example, stroke rate, nausea rate, and pain scores.

In the next three steps, the system gathers information regarding a second proposed treatment protocol using the data gathering techniques defined in Steps 110-130 above. For example, in Step 140, the system obtains the cost of labor and materials associated with a second proposed treatment protocol. The system then obtains, in Step 150, a patient satisfaction level associated with this second proposed treatment protocol. In Step 160, the system continues by obtaining a protocol quality indicator that indicates the quality of results from this second proposed treatment protocol.

Next, the system assigns ratings to the first and second patient treatment protocols. At Step 170, the system assigns a rating to the first protocol based on information regarding the cost of labor and materials and patient satisfaction level for the first proposed protocol, as well as the protocol quality indicator for the first proposed protocol obtained in Step 130. Similarly, at Step 180, the system assigns a rating to the second protocol based on information regarding the cost of labor and materials and patient satisfaction level for the second proposed protocol, as well as the protocol quality indicator for the second proposed protocol obtained in Step 150.

The system then advances to Step 190, where it performs a comparison of the first and second proposed protocol ratings. The system then determines, at Step 195, which of the first and second treatment protocols to implement as the optimized treatment protocol based, at least in part, on the comparison made at Step 190. Using the post-op treatment example discussed above, the comparison of Step 190 may determine that because the first treatment protocol results in very low incidences of patient nausea and vomiting, it actually delivers a cost savings in comparison with the second treatment protocol—even if the labor and material costs associated with the first treatment protocol are higher than those associated with the second treatment protocol. In this case, in Step 195, the system communicates to the user that the first treatment protocol should be implemented as the optimized treatment protocol based, at least in part, on the comparison between the two protocols.

Cost-Based Treatment Optimization Module

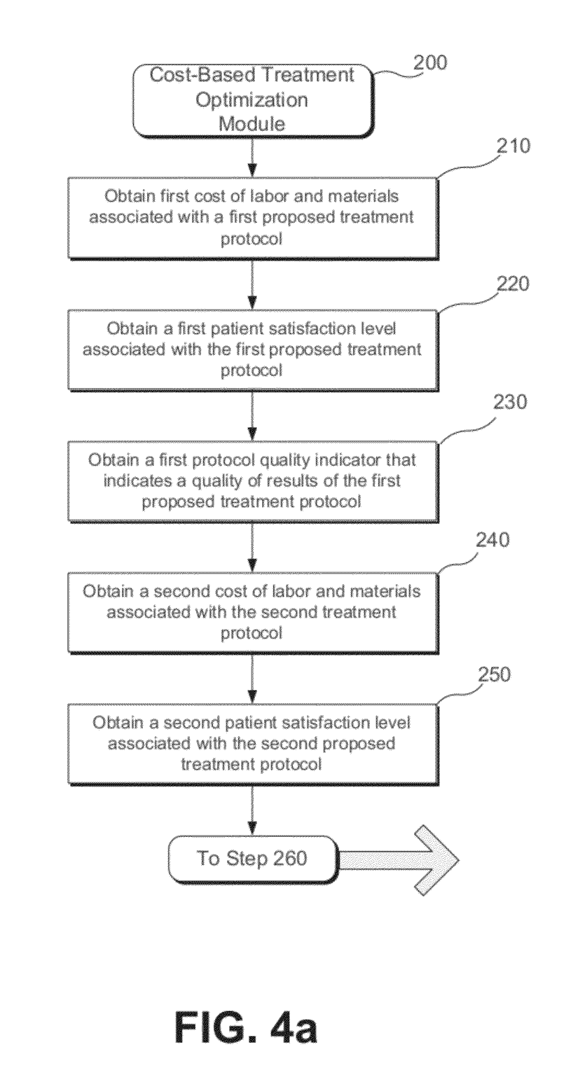

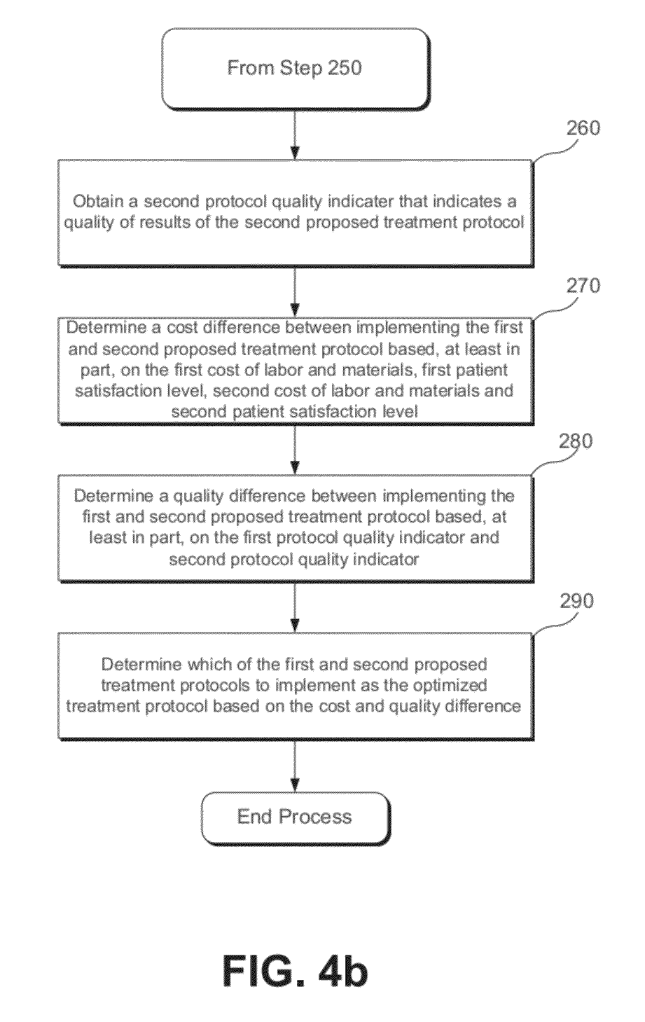

FIG. 4 is a flow chart of an exemplary Cost-Based Treatment Optimization Module 200. As may be understood from FIG. 4, certain embodiments of the Cost-Based Optimization Module 200 are configured to allow a system user to determine an optimized patient treatment protocol based on data gathered between two treatment protocols. For example, the system may be used to determine which of two post-op treatments are most effective with regard to cost, quality of results, and patient satisfaction. Beginning at Step 210, point of service billing data, employee productivity statistics, and data entered by one or more medical professionals through wireless devices are used to obtain the cost of labor and materials associated with this proposed treatment protocol. The system then obtains, in Step 220, a patient satisfaction level associated with this proposed protocol. This satisfaction level is derived from a survey of one or more patients who have received the treatment protocol. In Step 230, the system continues by obtaining a protocol quality indicator obtained from a surveyed group of patients using this treatment protocol. Variables that may be considered include, for example, stroke rate, nausea rate, and pain scores.

In the next three steps, the system gathers information on a second proposed treatment protocol using the data gathering techniques defined in Step 210, Step 220, and Step 230. In Step 240, the system obtains the cost of labor and materials associated with a second proposed treatment protocol. The system then obtains, in Step 250, a patient satisfaction level associated with this second proposed protocol. In Step 260, the system continues by obtaining a protocol quality indicator that indicates the quality of results from this second proposed treatment protocol.

Next, the system determines cost and quality differences between the two patient treatment protocols. In Step 270 the system determines the cost difference between implementing the first and second proposed treatment protocols based on information obtained about the cost of labor and materials, patient satisfaction level, and the patient satisfaction levels of the first and second proposed protocol. In Step 280, the system determines a quality difference between implementing the first and second proposed treatment protocols based on information obtained about the protocol quality indicator of the first and second proposed protocol.

The system then performs a comparison of the first and second proposed protocol ratings in Step 290, and determines which of the treatment protocols to implement as the optimized treatment protocol based on cost and quality differences. For example, the system may convert data regarding quality of results into quantified cost savings associated with not having to treat patients for nausea using the first treatment protocol. The system will recommend the first treatment protocol to system users based on these cost savings.

Drug Selection Module

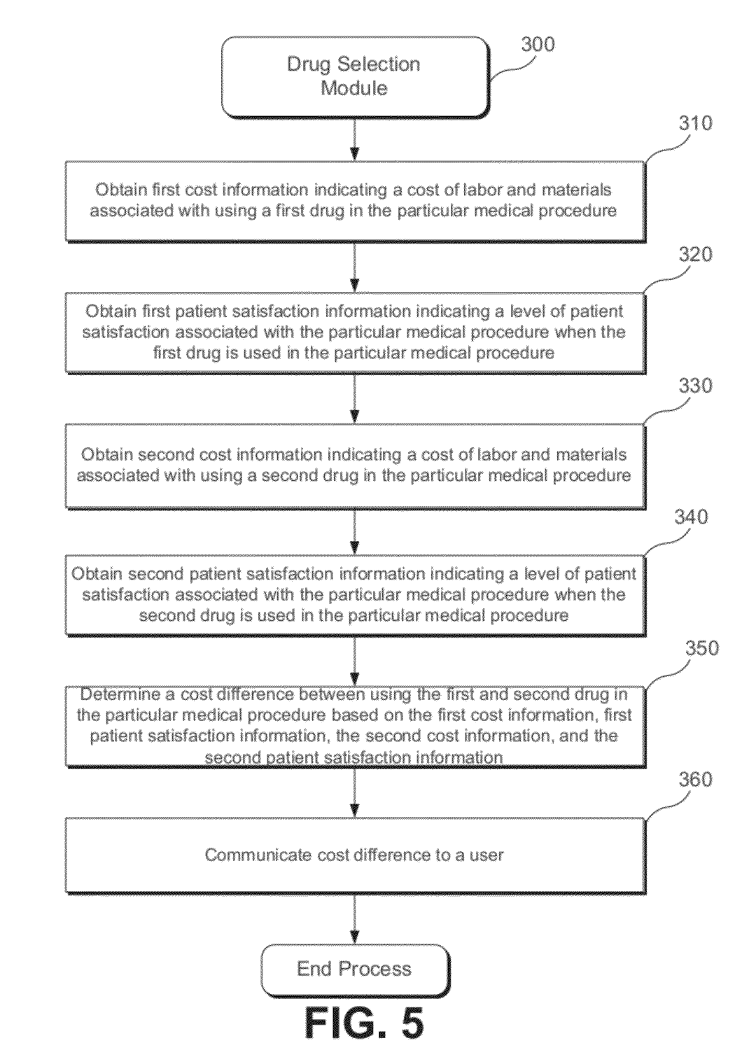

FIG. 5 is a flow chart of an exemplary Drug Selection Module 300. As may be understood from FIG. 5, certain embodiments of the Drug Selection Module 300 are configured to determine which drug to use in the context of a particular medical procedure based on data regarding the past usage of two different drugs. For example, the system may be used to determine which of two post-op pain blocks used for a particular medical procedure are most effective with regard to cost, quality of results, and patient satisfaction.

Beginning at Step 310, the system may obtain the cost of labor and materials associated with using a particular drug in a post-op situation. This cost may be obtained, for example, from point of service billing data, employee productivity statistics, and data entered by one or more medical professionals through wireless devices. The system then obtains, in Step 320, a patient satisfaction level derived from a survey of one or more patients who have received this drug in the context of the particular medical procedure.

In the next two steps, the system gathers information on a using second drug in the same medical procedure using the data gathering techniques defined in Step 310 and Step 320. In Step 330, the system obtains the cost of labor and materials associated with using this second drug using, for example, the methods discussed above. The system then obtains, in Step 340, a patient satisfaction level associated with this second proposed drug.

Next, the system determines cost differences between using the two drugs in the same medical procedure. In Step 350, the system converts cost and patient satisfaction levels data into a quantified cost difference between using the first and second drug. In Step 360, the system communicates the overall cost difference between using the two drugs to a system user, who can then make an informed decision on which post-op pain block to use.

Treatment Technique Determination Module

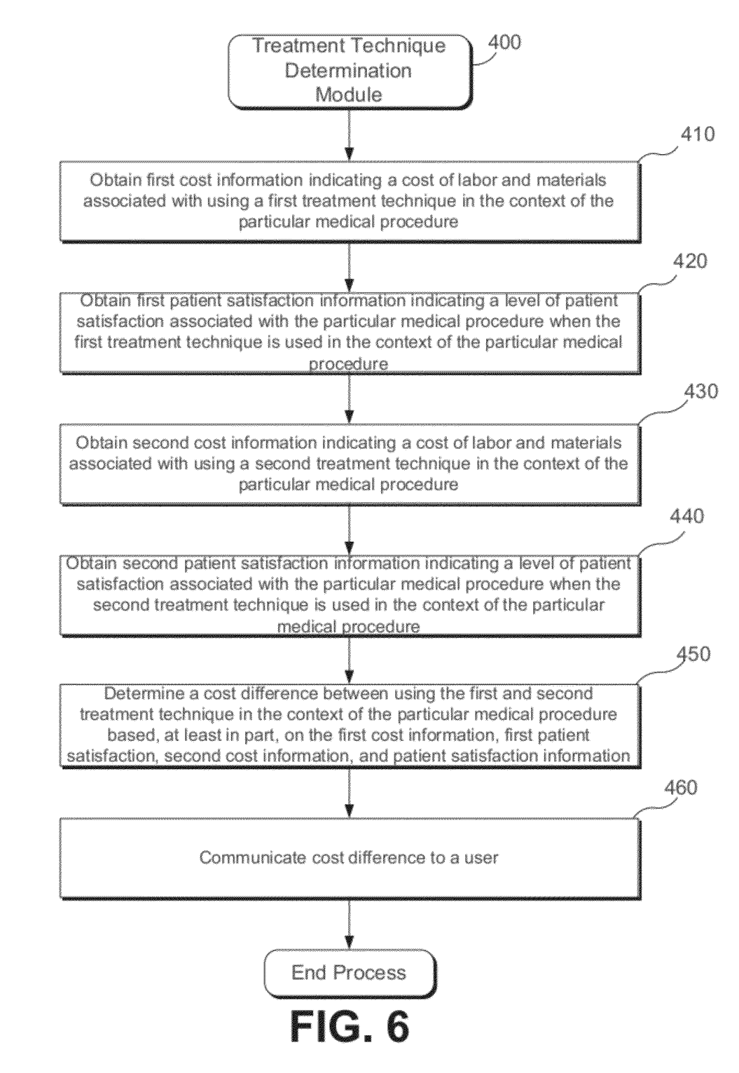

FIG. 6 is a flow chart of an exemplary Treatment Technique Determination Module 400. As may be understood from FIG. 5, certain embodiments of the Treatment Technique Determination Module 400 are configured to allow a system user to determine which treatment technique to use in the context of a particular medical procedure based on data gathered between using two different treatment techniques. For example, the system may be used to determine which of two techniques for administering anesthesia are most effective with regard to cost and patient satisfaction.

Beginning at Step 410, the system may obtain the cost of labor and materials associated with using a treatment technique for administering anesthesia. This cost is obtained, for example, from point of service billing data, employee productivity statistics, and data entered by one or more medical professionals through wireless devices. The system then obtains, in Step 420, a patient satisfaction level derived from a survey of one or more patients who have received this treatment technique in the context of the particular medical procedure.

In the next two steps, the system gathers information on using a second treatment technique for administering anesthesia using, for example, the data gathering techniques defined in Step 410 and Step 420. In Step 430, the system obtains the cost of labor and materials associated with using this second treatment technique in the medical procedure. The system then obtains, in Step 440, a patient satisfaction level associated with this second proposed treatment technique.

Next, the system determines cost differences between the two treatment techniques by, for example, converting cost of labor and materials with patient satisfaction data into quantifiable cost differences. In Step 450, the system determines the cost difference between using the first and second treatment techniques based on information obtained about the cost and patient satisfaction levels of the first and second proposed treatment techniques. In Step 460, the system communicates the cost differences between the two treatment techniques to a system user, who can then determine which of the techniques to use based on the results.

### Exemplary User Interface

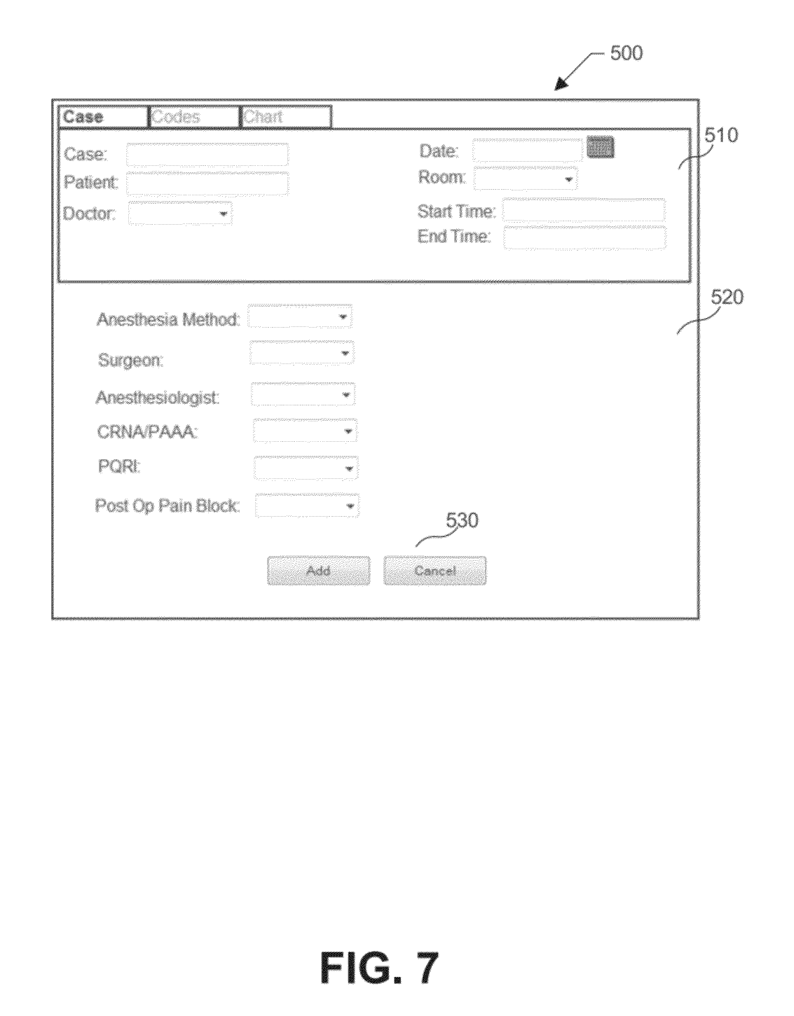

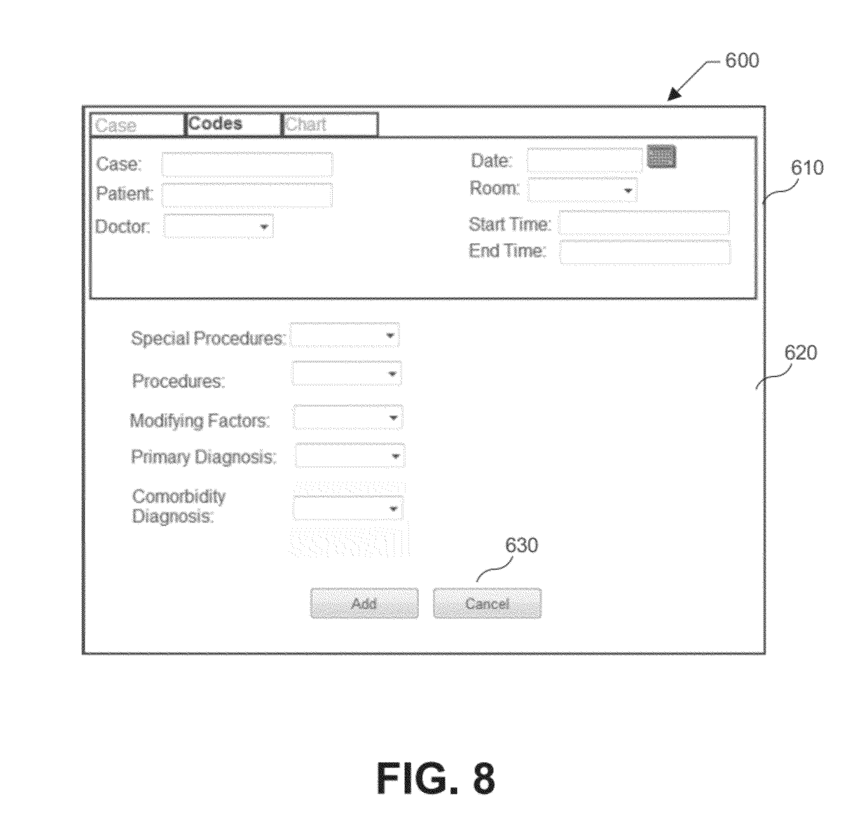

An exemplary user interface for a particular embodiment is shown in FIGS. 7 and 8. These figures represent interfaces displayed on tablet computers, desktop computers, laptops, and/or handheld devices, such as smart phones. These interfaces may be used by hospital staff and physicians to enter data at all points during a patient's visit.

For example, FIG. 7 shows the case home screen 500. This screen includes a section for general case information 510 whose proposed fields include a Case field, Patient field, Doctor Selection field, Date Selection field, Room Selection field, and Case Start and End Time fields. The remaining portion of the screen 520 contains various data entry fields, such as Anesthesia Method, Surgeon, Anesthesiologist, and other fields in which the user enters case data specific to the user visit. The user is able to type data into fields in addition to selecting options from a drop-down menu. Add and Cancel buttons 530 enable the user to add data to the database for later use in the context of the techniques described above.

FIG. 8 shows the codes home screen 600. This screen also includes a section for general case information 610 whose fields include a Case field, Patient field, Doctor Selection field, Date Selection field, Room Selection field, and Case Start and End Time fields. The remaining portion of the screen 620 contains data entry fields used for procedures, factors, and diagnoses. Add and Cancel buttons 630 enable the user to add the data to the data base for optimization on procedures.

As users log patient visit data using these two screens, the Optimization Server saves the date for use in optimizing future procedures. Data is analyzed and the best results for the total cost of the treatment are communicated to the system user.

### First Practical Application of Healthcare Optimization System—Choice of Anesthetic

A first practical application of the Healthcare Optimization System via the Drug Selection Module 300 of FIG. 5 may include the selection of a particular type of anesthetic for a particular medical procedure. A physician performing a tubal ligation on a patient, for example, may select between several suitable forms of anesthetic. Two such forms of anesthetic are a general anesthetic and an epidural.

In the first step of the Drug Selection Module 300, the system, at Step 310, may obtain the cost of labor and materials associated with the use of a general anesthetic during the performance of a tubal ligation. This cost is obtained from point of service billing data, employee productivity statistics, and data entered by one or more medical professionals through wireless devices. In Step 320, the system obtains a patient satisfaction level derived from surveys of patients who received a general anesthetic during a tubal ligation. The survey may inquire into the patient's happiness or unhappiness with the procedure, their overall rating of the procedure, whether they would suggest the procedure to others, or any other questions that may reflect the patient's level of satisfaction.

In the next steps, the system gathers information on using an epidural during a tubal ligation. In Step 330, the system may obtain the cost of labor and materials associated with the use of an epidural in the context of a tubal ligation. The system then, in Step 340, obtains a patient satisfaction level for patients who received an epidural during a tubal ligation using similar techniques to obtaining the satisfaction levels of the patients who received a general anesthetic in Step 320.

Next, the system determines the overall cost difference of using a general anesthetic versus using an epidural during a tubal ligation. In Step 350, the system converts cost and patient satisfaction levels into a quantified cost difference between the use of a general anesthetic versus the use of an epidural during a tubal ligation. In Step 360, the system communicates the cost differences between a general anesthetic and an epidural in a tubal ligation to a system user (e.g., by displaying the information on a computer display screen or by printing the information using a conventional printer), who can then make an informed decision on which form of anesthetic to use in future tubal ligations.

### Second Practical Application of Healthcare Optimization System—Cost Based Optimization

The Cost-Based Optimization Module 200 of FIG. 4 may allow a system user to determine which of two post-op treatment protocols may be most effective with regard to cost, quality of results, and patient satisfaction. A second practical application of the Healthcare Optimization System via the Cost-Based Optimization Module 200 may include a determination of whether to administer a peripheral nerve block for postoperative pain relief for a patient who has undergone a total knee replacement.

At Step 210, point of service billing data, employee productivity statistics, and data entered by one or more medical professionals through wireless devices are used to obtain the cost of labor and materials associated with the use of the peripheral nerve block. Step 210 may include consideration of the cost of additional treatment that is foregone by the use of the peripheral nerve block. For example, the use of a peripheral nerve block may limit the narcotics needed by a patient for postoperative pain relief. The system then obtains, at Step 220, a patient satisfaction level associated with the use of a peripheral nerve block following a total knee replacement. The patient satisfaction level is obtained through surveys of patients that have received a peripheral nerve block following a total knee replacement. Questions included in a patient satisfaction survey may include whether the patient is happy or unhappy with the procedure, what the patient's level of satisfaction with the procedure is, whether the patient would recommend the procedure to another, and any other questions that may determine the patient's level of satisfaction.

The system continues, in Step 230, by obtaining a protocol quality indicator obtained from a surveyed group of patients that received a peripheral nerve block following a total knee replacement. Variables considered in obtaining a protocol quality indicator include stroke rate, nausea rate, and pain scores. For example, a patient receiving a peripheral nerve block following a total knee replacement may experience less pain than a patient not receiving a peripheral nerve block such that the patient receiving the peripheral nerve block is able to be discharged from the hospital a day earlier. Such a result would be an indicator of high protocol quality.

In Steps 240, 250, and 260 the system gathers information on an alternative protocol of not administering a peripheral nerve block following a total knee replacement using the data gathering techniques defined in Step 210, 220, and 230. In Step 240, the system obtains the cost of labor and materials associated with not administering a peripheral nerve block. These costs may include the cost of additional treatments that are required in the absence of a peripheral nerve block such as the administration of pain killing narcotics. The system then obtains, in Step 250, a patient satisfaction level associated with patients who are not given a peripheral nerve block following a total knee replacement. In Step 260, the system continues by obtaining a protocol quality indicator that indicates the quality of the results of not administering a peripheral nerve block following a total knee replacement.

The system next determines a cost and quality difference between administering a peripheral nerve block following total knee replacement and not administering one. In Step 270, the system determines a cost difference between administering a peripheral nerve block and not based at least in part on the cost of labor and materials and the patient satisfaction levels of the two protocols. In Step 280, the system determines a quality difference between the use and non-use of a peripheral nerve block following total knee replacement based at least in part on the protocol quality indicators of the two protocols.

Finally, in Step 290, the system will determine whether or not to administer a peripheral nerve block following a total knee replacement based, at least in part, on the cost and quality difference obtained in Steps 270 and 280.

### CONCLUSION

Many modifications and other embodiments of the invention will come to mind to one skilled in the art to which this invention pertains having the benefit of the teachings presented in the foregoing descriptions and the associated drawings. While examples discussed above cover the use of the invention in the context of medical-related decisions, the invention may be used in any other suitable context. Also, although the above techniques are described as being used to decide between two different treatment protocols, it should be understood that similar techniques may be used to choose between three or more different treatment protocols. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

I claim:

1. A computer system for determining an optimized patient treatment protocol, said computer system comprising a processor and memory, said computer system being adapted to perform the steps of:
obtaining a first cost of labor and materials associated with a first proposed treatment protocol;
obtaining a first patient satisfaction level associated with said first proposed treatment protocol;
obtaining a first protocol quality indicator that indicates a quality of results of said first proposed treatment protocol;
obtaining a second cost of labor and materials associated with a second proposed treatment protocol;
obtaining a second patient satisfaction level associated with said second proposed treatment protocol;
obtaining a second protocol quality indicator that indicates a quality of results of said second proposed treatment protocol; and
assigning a first rating to said first proposed treatment protocol based, at least in part, on said first cost of labor and materials, said first patient satisfaction level, and said first protocol quality indicator;
assigning a second rating to said second proposed treatment protocol based, at least in part, on said second cost of labor and materials, said second patient satisfaction level, and said second protocol quality indicator;
performing a comparison of said first and second ratings; and
based, at least in part, on said comparison, determining which of said first and second proposed treatment protocols to implement as said optimized treatment protocol.

2. The computer system of claim 1, wherein said first treatment protocol comprises using a particular anesthetic to anesthetize a patient.

3. The computer system of claim 1, wherein said first treatment protocol comprises administering a particular drug to a patient.

4. The computer system of claim 1, wherein said first treatment protocol comprises performing a particular medical procedure on a patient.

5. The computer system of claim 1, wherein said computer system is adapted for determining, based at least in part on said comparison, which of said first and second proposed treatment protocols would result in a greater amount of CMS reimbursement.

6. The computer system of claim 1, wherein said computer system is adapted for use in maximizing CMS reimbursement for one or more medical procedures.

7. The computer system of claim 1, wherein said computer system is adapted for use, by an anesthesia department, in quantifying said anesthesia department's contribution to one or more cost reductions.

8. A computer-implemented method of determining an optimized treatment protocol, said method comprising:
obtaining a first cost of labor and materials associated with a first proposed treatment protocol;
obtaining a first patient satisfaction level associated with said first proposed treatment protocol;
obtaining a first protocol quality indicator that indicates a quality of results of said first proposed treatment protocol;
obtaining a second cost of labor and materials associated with a second proposed treatment protocol;
obtaining a second patient satisfaction level associated with said second proposed treatment protocol;
obtaining a second protocol quality indicator that indicates a quality of results of said second proposed treatment protocol;
determining a cost difference between implementing said first proposed treatment protocol and implementing said second proposed protocol;
determining a quality difference between implementing said first proposed treatment protocol and implementing said second proposed protocol; and
determining, based at least on said cost difference and said quality difference, which of said first and second proposed treatment protocols to implement as said optimized treatment protocol, wherein:
said step of determining said cost difference is based, at least in part, on said first cost of labor and materials, said first patient satisfaction level, said second cost of labor and materials, and said second patient satisfaction level, and
said step of determining said quality difference is based, at least in part, on said first protocol quality indicator and said second protocol quality indicator.

9. The method of claim 8, wherein:
said step of obtaining said first cost of labor and materials associated with said first proposed treatment protocol comprises obtaining point of service billing data associated with said first proposed treatment protocol; and
said step of obtaining said second cost of labor and materials associated with said second proposed treatment protocol comprises obtaining point of service billing data associated with said second proposed treatment protocol.

10. The method of claim 8, wherein:
said step of obtaining said first cost of labor and materials associated with said first proposed treatment protocol comprises obtaining employee productivity data associated with said first proposed treatment protocol; and
said step of obtaining said second cost of labor and materials associated with said second proposed treatment protocol comprises obtaining employee productivity data associated with said second proposed treatment protocol.

11. The method of claim 8, wherein:
said step of obtaining said first cost of labor and materials associated with said first proposed treatment protocol comprises analyzing data that has been obtained, from one or more medical professionals, via a plurality of wireless devices.
said step of obtaining said second cost of labor and materials associated with said second proposed treatment protocol comprises analyzing data that has been obtained, from one or more medical professionals, via said plurality of wireless devices.

12. The method of claim 8, wherein said method further comprises displaying, to each of a plurality of entities: (A) said first cost of labor and materials; (B) said first patient satisfaction level; (C) said first protocol quality indicator; (D) said second cost of labor and materials; (E) said second patient satisfaction level; and (F) said second protocol quality indicator.

13. The method of claim 8, wherein:
said first cost of labor and materials takes into account one or more bonuses or penalties for patient satisfaction related to said first proposed treatment protocol; and
said second cost of labor and materials takes into account one or more bonuses or penalties for patient satisfaction related to said second proposed treatment protocol.

14. The method of claim 13, wherein:
said first protocol quality indicator is based, at least in part, on one or more variables selected from a group consisting of: (A) stroke rate; (B) nausea rate; and (C) one or more pain scores; and
said second protocol quality indicator is based, at least in part, on one or more variables selected from a group consisting of: (A) stroke rate; (B) nausea rate; and (C) one or more pain scores.

15. A computer system for use in determining which drug to use in the context of a particular medical procedure, said computer system comprising:
a processor; and
memory, wherein said computer system is adapted for:
(A) obtaining first cost information indicating a cost of labor and materials associated with using a first drug in said particular medical procedure;
(B) obtaining first patient satisfaction information indicating a level of patient satisfaction associated with said particular medical procedure when said first drug is used in said particular medical procedure;
(C) obtaining second cost information indicating a cost of labor and materials associated with using a second drug in said particular medical procedure;
(D) obtaining second patient satisfaction information indicating a level of patient satisfaction associated with said particular medical procedure when said second drug is used in said particular medical procedure;
(E) determining a cost difference between: (1) using said first drug in said particular medical procedure; and (2) using said second drug in said particular medical procedure; and
(F) communicating said cost difference to a user, wherein:
said computer system is adapted for, at said Step (E), determining said cost difference based, at least in part, on said first cost information, said first patient satisfaction information, said second cost information, and said second patient satisfaction information.

16. The computer system of claim 15, wherein said computer system is further adapted for:
(G) obtaining first quality information indicating a quality of results achieved in using said first drug in said particular medical procedure;
(H) obtaining second quality information indicating a quality of results achieved in using said second drug in said particular medical procedure;
(I) determining a quality difference between the results achieved in: (1) using said first drug in said particular medical procedure; and (2) using said second drug in said particular medical procedure; and
(F) communicating said quality difference to a user.

17. The computer system of claim 15, wherein:
said computer system comprises a plurality of handheld devices, each of which is adapted to allow a medical professional to input medical procedure data regarding one or more executions of said medical procedure; and
said computer system is adapted to use said medical procedure data to generate said first and second quality information.

18. The computer system of claim 15, wherein:
said first drug is a first anesthetic; and
said second drug is a second anesthetic.

19. The computer system of claim 15, wherein:
said first patient satisfaction information is derived from a survey of one or more patients who have received said first drug in the context of said particular medical procedure; and
said second patient satisfaction information is derived from a survey of one or more patients who have received said second drug in the context of said particular medical procedure.

20. The computer system of claim 15, wherein said computer system is further adapted for, at said Step (E):
determining a reduction in payment associated with said first patient satisfaction information; and
determining said cost difference based, at least in part, on said reduction in payment.

21. The computer system of claim 20, wherein said reduction in payment corresponds to a reduced insurance payment associated with a particular level of customer satisfaction.

22. The computer system of claim 15, wherein said computer system comprises one or more databases for storing said first cost information, said first patient satisfaction information, said second cost information, and said second patient satisfaction information.

23. A computer system for use in determining which treatment technique to use in the context of a particular medical procedure, said computer system comprising:
a processor; and
memory, wherein said computer system is adapted for:
(A) obtaining first cost information indicating a cost of labor and materials associated with using a first treatment technique in the context of said particular medical procedure;
(B) obtaining first patient satisfaction information indicating a level of patient satisfaction associated with said particular medical procedure when said first treatment technique is used in the context of said particular medical procedure;
(C) obtaining second cost information indicating a cost of labor and materials associated with using a second treatment technique in the context of said particular medical procedure;
(D) obtaining second patient satisfaction information indicating a level of patient satisfaction associated with said particular medical procedure when said second treatment technique is used in the context of said particular medical procedure;
(E) determining a cost difference between: (1) using said first treatment technique in the context of said particular medical procedure; and (2) using said second treatment technique in the context of the particular medical procedure; and
(F) communicating said cost difference to a user, wherein:
said computer system is adapted for, at said Step (E), determining said cost difference based, at least in part, on said first cost information, said first patient satisfaction information, said second cost information, and said second patient satisfaction information.

24. The computer system of claim 23, wherein:
said first treatment technique is a technique for administering an anesthetic; and
said second treatment technique is a technique for administering an anesthetic.

25. The computer system of claim 23, wherein said computer system is further adapted for:
(G) obtaining first quality information indicating a quality of results achieved in using said first treatment technique in the context of said particular medical procedure;
(H) obtaining second quality information indicating a quality of results achieved in using said second treatment technique in the context of said particular medical procedure;
(I) determining a quality difference between results achieved in: (1) using said first treatment technique in the context of said particular medical procedure; and (2) using said second treatment technique in the context of said particular medical procedure; and
(F) communicating said quality difference to a user.

26. The computer system of claim 25, wherein:
said first patient satisfaction information is derived from a survey of one or more patients on which said first treatment technique has been performed in the context of said particular medical procedure; and
said second patient satisfaction information is derived from a survey of one or more patients on which said second treatment technique has been performed in the context of said particular medical procedure.

27. The computer system of claim 23, wherein said computer system is further adapted for, at said Step (E):
determining a reduction in payment associated with said first patient satisfaction information; and
determining said cost difference based, at least in part, on said reduction in payment.

28. The computer system of claim 27, wherein said reduction in payment corresponds to a reduced insurance payment associated with a particular level of customer satisfaction.

29. The computer system of claim 23, wherein said computer system comprises one or more databases for storing said first cost information, said first patient satisfaction information, said second cost information, and said second patient satisfaction information.
